(19) United States
(12) Patent Application Publication
(10) Pub. No.: US 2007/0040807 A1
(43) Pub. Date: Feb. 22, 2007

(54) Keyboard

(76) Inventor: Robert E. Kleve, Grand Forks, ND (US)

Correspondence Address: ROBERT E. KLEVE, 1103-24TH AVE S., GRAND FORKS, ND, 58201, US

(21) Appl. No.: 11/585,582

(22) Filed: Oct. 24, 2006

Related U.S. Application Data
(63) Continuation-in-part of application No. 11/045,905, filed on Jan. 28, 2005, now abandoned.
(60) Provisional application No. 60/540,979, filed on Jan. 30, 2004.
(60) Provisional application No. 60/637,206, filed on Dec. 15, 2004.

(51) Int. Cl. G09G 5/00

(52) U.S. Cl. 345/168

(57) ABSTRACT

The invention comprise a one hand keyboard having thumb and finger receptacles for the thumb and fingers to signal the entire alphabet of a language, all numbers, and all essential punctuation with the fingers tips and thumb that need only move the them a fraction of or less than an inch and the alphabet may arranged in alphabetical order to provide signals for use, by the fingers and thumb, to type the letters of the alphabet to form written communications with words and etc., with the signals, while the signals are arranged on the keyboard in alphabetical order.

This application is a continuation in part of my earlier pending patent application Ser. No. 11/045,905 filed on 01/28/2005. This relates to one hand keyboards. The invention is also related to my previous U.S. Pat. No. 5,581,127. This invention also relates to my earlier provisional U.S. Patent Applications Ser. No. 60/540,979, filed Jan. 20, 2004, and Ser. No. 60/637,206, filed Dec. 15, 2004 and priority is claimed as to both provisional applications.

It is ah object of the invention to provide a novel keyboard where the fingers and thumb may be used to signal the entire alphabet of a language, all numbers, and all essential punctuation with the fingers tips and thumb that need only move the them a fraction of or less than an inch and the alphabet may arranged in alphabetical order to provide signals for use, by at least the fingers, to type the letters of the alphabet to form written communications with words and etc., with the signals, while the signals are arranged on the keyboard in alphabetical order.

It is another object of the invention to provide a one hand keyboard in which any letter in the entire alphabet and any number may be entered or registered in a computer or print out by the four finger tip controls and thumb; and further necessary controls such as capitalization, space bar, back space, delete, may be further provided by the thumb movement and its control thereof.

It is another object of the invention to provide a novel essentially one hand keyboard which may be operated to provide numerous selected signals in excess of the letters of the alphabet by providing finger and thumb movement of relatively short distances by providing several movements of the finger or thumb to provide a signal, while providing at least one movement by the finger or thumb to shift the signal provided by the fingers and thumb to a new set of signals by the fingers and thumb with the signals arranged in alphabetical order with each succeeding shift.

It is another object of the invention to provide an improved finger receptacle and improved linkage of the receptacle to its base for easier operation of the receptacles

### BACKGROUND OF THE INVENTION

In the past keyboards have customarily required horizontal lateral and longitudinal hand and arm movement as well as finger movement. It is an object of this invention to require essentially only finger tip and thumb movement for, if desired, all essential elements of a keyboard, such as typing the alphabet, numbers, and punctuation, and essential controls, such as enter, space bar, capitalization, and back space.

In the past, since arm and hand movement is also required to reach the aforementioned elements and controls, and the letters of the alphabet have not been arranged in alphabetical order, but rather with the more frequently used letters of the alphabet closer to the operators fingers so that less movement of the hands and arms are required.

In this invention, no essential hand and aim movement is required. The only movement needed being forward and rearward movement of the fingers for the letters and downward movement to change from one portion of the alphabet to another, and a downward thumb movement for several letters; and this movement is essentially the same distance for all fingers and the thumb.

Consequently; there is no reason not to arrange the letters in alphabetical order, and the letters can easily be arranged in alphabetical order by dividing the alphabet can be divided into three sections. The forward and rearward movement of the fingers causes signals to type the letters of the first third of the alphabet. The downward movement of the first or second fingers causes a shifting movement of the signals to shift to the second or third set of letters for the forward and rearward switches of the fingers that cause the signals, enabling the operator to shift from one section of the alphabet to another. By maintaining first or second fingers downward; the typing the letters in the middle third or last third section of the alphabet is provided by simultaneously moving the fingers forward or rearward. The thumb down movement is also arranged in alphabetical left to right order with the fingers and its signal also shifted by the downward movement of the fingers so that all the letters of the alphabet can be provided.

### BRIEF DESCRIPTION OF THE DRAWINGS

FIG. 1 is a top view of the one handed keyboard.

FIG. 2 is a top view of the keyboard with the cover cutaway.

FIG. 3 is a side view of the thumb and the four finger receptacles, with the thumb cover removed.

FIG. 4 is a side elevational view of the four finger receptacles taken along line 4-4 of FIG. 1.

FIG. 5A is a side view of the finger receptacle and stand with the link member and receptacle in neutral.

FIG. 5B is a side view of the finger receptacle and stand with the receptacle pivoted forward through its link member and engaging and actuating the forward switch.

FIG. 5C is a side view of the finger receptacle and stand with the receptacle pivoted rearward through its link member and engaging and actuating the rear switch.

FIG. 6 is a side of the finger receptacle in its lower shifted position with the receptacle in its neutral position.

FIG. 6B is a side view of the finger receptacle in its lower shifted position and the receptacle pivoted forward and engaging and actuating the forward switch.

FIG. 6C is a side view of the finger receptacle in its lower shifted position and the receptacle pivoted rearward and engaging and actuating the rear switch.

FIG. 7 is a perspective view of the finger receptacle and link member.

FIG. 8 is a top view of the thumb receptacle.

FIG. 9 is a rear view of the thumb receptacle taken along line 8-8 of FIG. 8.

FIG. 10 is a perspective view of the finger arm receptacle modification.

FIG. 11 is a side view of the finger arm receptacle and stand modification.

FIG. 12 is a side view of the finger arm modification.

FIG. 13 is a schematic electrical circuitry diagram of the switching circuitry.

FIG. 14 top view of the thumb and switching arrangement with the thumb receptacle and thumb arm in neutral.

FIG. 14A is a top view of thumb receptacle and thumb arm with the thumb and thumb are pivoted to the left to engage and actuate the “enter” switch.

FIG. 14B is a top view of the thumb receptacle and thumb arm with the receptacle and arm pivoted to the right to engage and actuate the “space bar” switch.

FIG. 15A is a top view of the thumb receptacle pivoted clockwise on its pivot to engage and actuate the “capitalization lock” switch

FIG. 15B is a top view of the thumb receptacle pivoted counterclockwise on its pivot to engage and actuate the “back space”.

### BRIEF DESCRIPTION OF PREFERRED EMBODIMENT

Briefly stated, the invention comprises a one hand keyboard having four finger receptacles and a thumb receptacle for receiving the four fingers and thumb respectively of an operator. The operator need only move the fingers and thumbs in the receptacles to operator the keyboard. The fingers can move any of the four finger receptacles forward and rearward for a signal for letters, numbers, and punctuation, with the four fingers receptacles capable of moving downward by any one of the fingers to selectively to change setting of the signals. The letters of the alphabet are arranged alphabetically in order in three sets, with the numbers arranged numerically in one set, and punctuation arranged in one setting.

The keyboard 20 has a main base panel 21. The base panel has a forward leg support 22. A thumb apparatus 23 and four finger receptacles apparatus 24,24′,24″, 24′″ are mounted on the base panel 21 beside one another. The thumb apparatus 23 has a thumb receptacle 23′, and each finger receptacle apparatus has a finger receptacle 25,25′,25″25′″, to receive the thumb and four fingers, respectively, of the right hand of an operator. A rectangular cover 26 is mounted over the top of the four finger receptacle and thumb receptacle. The cover 26 has an arcuate slot 27 in its top directly over the receptacles to allow the four fingers and thumb access to their respective receptacles. A top base portion 28 on the top of the cover is formed in an arcuate shape directly behind the arcuate slot serving as a palm support rest for the palm of the right hand of the operator.

The front upright panel 22, serving as a forward leg support, is mounted across the front edge of the base and extending downward. It serves as a forward leg support for the keyboard so that the keyboard may rest inclined on a surface with the rear edge 22′ of the panel resting on the surface and front edge inclined upward, having its panel resting on the surface. The four finger receiving apparatus 24,24′, 24″ and 24′″ each have the four finger receptacles 25,25′,25″ and 25′″, and four link members 31,31′,31″,31′″ are provided for the four finger receptacles respectively.

Each stand 30 has a horizontal base 30′ fixed across the bottom of the upright plate 30″ of the stand 30. The stand base 30′ is bolted to the main base 21 of each finger receiving apparatus 24-24′″ with each finger receptacle adjacent one another on the main base. Each stand has three switches, generally referred to by numerals 29,29′, and 29″, or specifically referred to by the first stand as 33, 33′, 37 and are screwed to the upright base plate 30″. The four finger receptacles 25,25′,25″, and 25′″ are pivotally mounted to their respective link members 31,31′,31″,31′″ at pivot 29 and the link members, in turn, are pivotally mounted to their upright stand 30 at pivot 29′.

The finger receiving apparatus 24-24′″ have forward signal switches 33,34,35,36, respectively, and rearward signal switches 33′,34′,35′, and 36′, respectively, on their stands which provide signals for the keyboard. The stands have shift switches 37,38,39,40, respectively, on their stands beneath their respective finger receptacle, which shift the signals provided to these forwards and rearward switches to one of five different sets of signals. Which set of signals being provided or activated depends upon which shift switch has been activated by the downward movement of one of the finger receptacles by one of the fingers of the operator's hand pushing downward in one of the four finger receptacles.

First Modification to Finger Receptacle

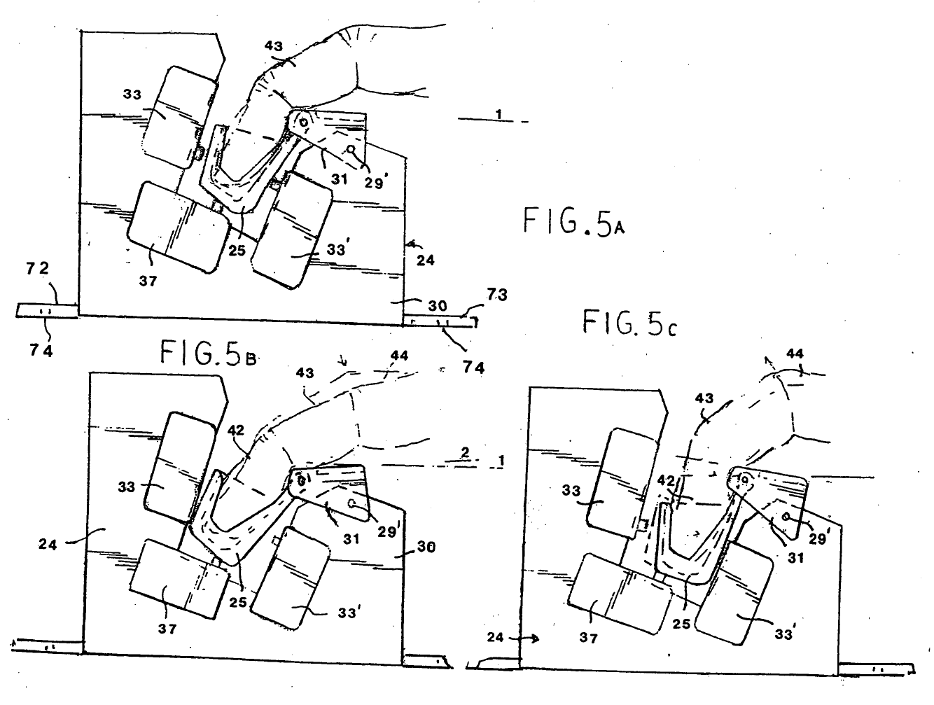

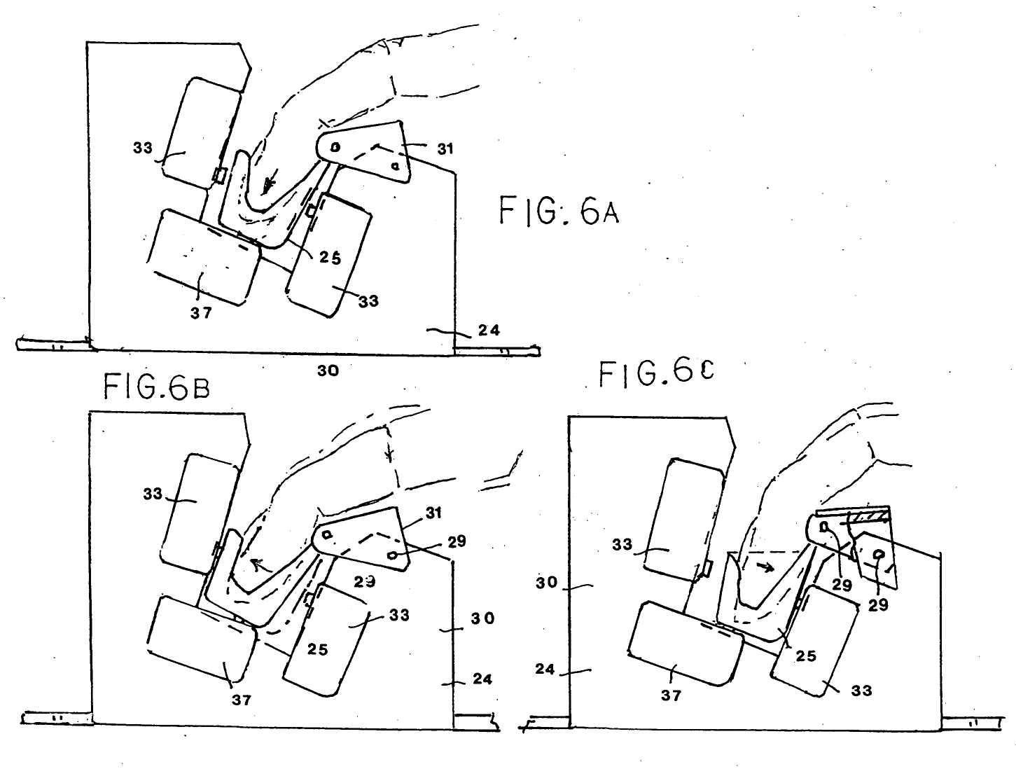

This is the first preferred modification to the finger receptacle construction of my earlier patent. This first preferred modification uses the link members 31-31′″ similar to my earlier patent and has the finger receptacle 25-25′″ which is essentially the same as the finger receptacle 20 in the January 04 provisional application. The drawings, FIGS. 5-6c, inclusive show the finger receptacle and link member in its various positions as will be later described. With this latest preferred modification being now described; the finger receptacle 25 directly engages the shift switch beneath the receptacle with its downward movement The link member 31, at its forward end, is directly pivotally mounted at pivot 31′ to the upper end of the receptacle 25 and is pivotally mounted to the stand 30, at its other end, at pivot 31″ as shown in FIG. 4. The receptacle 25 serves the function of a finger tip in its operation, as it receives the operator's finger tip 50, and moves when the finger tip moves.

The four receptacles 25-25″″ operate in identical manner, through the link members 31-31′″. Each have six positions as illustrated in FIGS. 5-6c with respect to receptacle 25. The receptacles are pivotal to their positions by the tip of the operator's finger 50 pivoting the receptacle.

1. They have an upper neutral position as shown in FIG. 5.

2. An upper forward position to engage and activate the forward switch to provide a signal as shown in FIG. 5b.

3. A pivotal rear upper position to engage and activate the rear switch to provide a signal as shown in FIG. 5c.

4. A lower neutral position to activate the shift switch to change the signals to all the forward and rearward switches of the four finger receiving apparatus, with the change in signals depending upon which of the four shift switches were engaged and activated as shown in FIG. 6.

5. A forward lower position to activate the forward switch while the bottom of the receptacle maintains its engagement with and depressing of the shift switch button to maintain the different signals to all the forward switches and rearward switches, depending upon which shift switch was activated as shown in FIG. 6b.

6. A rearward lower position to activate the rear switch while the bottom of the receptacle is maintained against the shift switch button to maintain its activation of the different signals to all forward and rearward switches, as shown in FIG. 6c.

The receptacle 25, through its linkage member 31, mimics or is similar in its operation in its six different positions to the movement of the finger tip 50 and first finger section 43 of a human's finger, that connects the finger tip 42 to the second section 44 of a human finger. The second section 44 of a human's finger is, in turn, is pivotally connected to at its rear joint to the palm of an operator's hand.

When a person's finger is extended forward and downward, or downward or forward, the finger tip, first and second finger sections straighten out with respect to one another at their joints. The link member 31 allows the receptacle 25 to more closely follow the actual straightening action of the finger as the finger is extended downward to engage the bottom switch 37, as it causes the receptacle and link member to also straighten out. If the finger receptacle is moved forward by the finger tip extending or straightening forward to cause the receptacle to engage the forward button 60 of switch 33, the link member and receptacle also tend to straighten out. The link member also allows the receptacle to follow the finger movement of the finger tip being more sharply angled relative to one another if the finger receptacle is moved rearward by the finger tip to cause the receptacle to engage the button 45′ of the rear switch 33′, by the receptacle being more sharply angled with respect to the link member 31.

By the linkage member 31 simulating or mimicking the movement of a human's finger first linkage member 25′ to his finger tip 42, the receptacle 25 movement is more in harmony similar to the actual finger tip movement of an operator's hand and thus works with less effort and more easily actuates the finger switches more easily.

The four improved finger receptacles each have one open side 46 and only one wall 47 to enable the finger receptacles arms to be placed closer together. This one side opening also allows and enables fingers of larger sizes to more be readily and easily received in and used to operate the finger receptacles, limited only by the spacing between the receptacles an the one wall for each receptacle. The bottom of the receptacle has a rounded socket like shape to receive and complement the rounded tip of the finger. It further has a semicircular groove 43′ ti receive the fingernail at the tip of the finger.

This preferred embodiment shows a shorter finger receptacle surrounding essentially only the finger tip up to the first joint of the finger, and the link member has been moved forward toward the receptacle so that the pivot between the receptacle and link member is approximately at the first joint of the finger and the rear pivot between the link member and the stand is approximately at the second joint of the finger to align more with the finger and joint movements of the finger. While the shift switch has been moved from directly beneath the link member to beneath the receptacle, the switch might remain beneath the link member if a suitably small switch or remote control of the switch might be found.

This link mechanism concept is preferred to the finger arm modification shown in the January 30 application.

Operation:

The finger receptacle operation is shown in sequence in FIGS. 5A,B, and C, and 6A,B, and c as to receptacle apparatus 24 and it receptacle 25; the operation is identical as to all four receptacles 25-25′″

By the operator placing his finger tip 42 in the receptacle 25 and moving the receptacle with his finger tip to its various positions while his finger tip remains in the receptacle, the switch apparatus is operated.

The finger receptacle 25 is shown in neutral as shown in FIGS. 4 and 5A.

The front and rear switches 33 and 33′ are signal switches activated by the forward and rearward pivotal movement of the receptacle.

By the operator pivoting his finger tip 42 forward, the receptacle 25 is pivoted forward to engage the button 60 of the forward switch 33 activating the forward switch as before as shown in FIG. 5B.

By the operator pivoting his finger tip 42 rearward, the receptacle 25 is pivoted rearward to its position and engages the activation button 45′ of the rearward switch 33′, as shown in FIG. 5C to activate the switch similarly as before.

The switches 37-40 beneath the receptacles are shift switches.

If the operator wishes to change the signal to the front and rear switches of the receptacles and the signal switch of the thumb, he will depress the selected finger receptacle to its lower neutral position as shown in FIG. 6. He may still activate the front and rear signal switches to that receptacle while maintaining the receptacle down against the button of the shift switch to maintain its activation

By the operator pushing his finger tip 45 downward to its position shown in FIG. 6A, the movement moves the receptacle 25 downward to its position in FIG. 6A and the bottom of the receptacle 25 directly engages the button 37″ of the shift switch to activate the shift switch to shift the signals of the forward and rearward switches 33 and 33′ to new signals.

The forward and rearward switches can be activated by their receptacle when the receptacle is in its lower position maintaining that particular shift switch activated.

Then, when the operator moves his finger tip forward while maintaining the receptacle downward to maintain shift switch 37 activated and moves the receptacle forward sufficiently to engage and activate the activation button 45 as well as shown in FIG. 6B, a new signal is provided by switch 33.

Similarly, when the operator pivots the finger tip 42 rearward to pivot the receptacle rearward, while holding or maintaining the receptacle downward, the receptacle 25 thereby engages the button 45′ of the shift switch 33′ as shown in FIG. 6C; and maintains shift switch 37 activated while moving the receptacle rearward until it engages the button 33″ of the rear switch and activates switch 33′; this activates a new signal for the rear switch 33′.

Thus, the receptacle directly engages the shift switch instead of the lever arm as provided in the earlier provisional application.

The receptacle 25 is shown in its downward neutral position with only the shift switch 37 activated in FIG. 4. When the operator pushes his finger tip downward and then forward, to activate the shift switch and forward switch simultaneously by moving the finger receptacle downward and then forward; the forward movement of the receptacle 20 lowers the linkage member 31, shown in FIG. 6B. Similarly, the downward and forward movement of the operator's finger lowers the first linkage 43 and second linkage 44 of the operators's finger, as shown in FIG. 6B.

Similarly, when the operator pushes his finger tip rearward and downward, as shown in FIG. 6C the rearward and downward movement of the operator's finger tip raises the first linkage and second linkage 43 and 44′ of the operator's finger as shown in FIG. 6C and it also causes the finger receptacle to move rearward and upward and raises the first linkage of the receptacle in FIG. 6C.

Thus, the raising movement of the linkage and receptacle again mimics the raising movement of the finger tip and first linkage, so that the finger receptacle movement and linkage movement are more in harmony with the finger tip movement and first linkage movement making it easier and smoother and requiring less physical effort on the part of the operator's finger tip and first linkage.

By having the two pivots 29 and 29″, front and rear, on the link member 31 at least somewhat similar in dimension and normal operation of the first and second finger joints 43′ and 44′ of the human operator's finger and the receptacle movement can be accomplished by the finger tip with less effort since the finger tip is following more closely its natural movement.

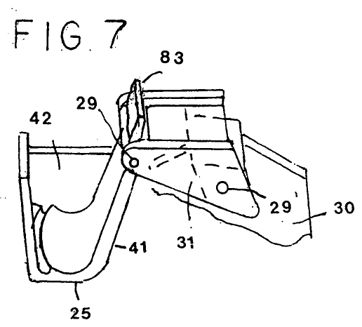

In FIG. 6, the link member 31 is cutaway to reveal the broad support base 36 on the stand to pivotally support the link member 31. The support base 36 is equal to the width of the receptacle 25 as shown in the perspective view FIG. 7 to provide a more stable pivot support for the linkage member and receptacle. As shown in FIG. 6 and 7, the linkage member has to similar side panels 35′ and 35″ and a connecting top panel 35, with top panel slightly wider than the support base 36, and outward toward the front to match the slight flaring out of the operators fingers when the fingers are spaced slightly outward at their forward portions.

Thumb Apparatus:

The thumb receptacle apparatus 23 has a main frame 45. The main frame 45 has a main horizontal plate 45′ and an upward plate 46 fixed to the main plate 45′. A main near fixed horizontal supporting plate 46′ is tilted downward forward and to the left toward the main horizontal plate 45′ which plate is fixedly mounted to the upward plate 46 of the keyboard.

An L shaped plate 47 is pivotally mounted to the near horizontal plate 46′ at the rear pivot 49. A thumb arm 49 is pivotally mounted to the slanted upward plate 47′ of the L shaped plate 47 to pivot upward and downward at a slant on rear pivot 54.

The thumb receptacle 23′ is pivotally mounted to a thumb arm 49 at forward pivot 50, to pivot to the tight or to the left on the plate 51 of the thumb arm to engage either switch 52 or 53 mounted on the plate 51 of the thumb arm.

The L shaped plate 47 slants the position of the thumb receptacle and thumb arm. Consequently, the operator may move the thumb downward with his thumb which causes the thumb receptacle and thumb arm to pivot on the rear pivot 54 downward to the right or upward to the left on the rear pivot 54. The downward movement of the thumb receptacle and thumb arm from its neutral position as shown causes the thumb arm to engage and activate the bottom switch 55 mounted beneath the thumb receptacle in fixed relation to the main frame 45. The angular supporting plate 46 thereby acts to tilt the thumb receptacle 23′ and thumb arm at a downward and outward angle for its movement to conform to the customary movement path of a right thumb, when operating the keyboard.

The operator may move the thumb receptacle 23′ with his thumb to the right or to the left without pivoting the thumb receptacle on its pivot 50. This causes the L shaped plate 47, to pivot on its pivot 48. It further causes the thumb arm and thumb receptacle to pivot on the pivot 48 with the L shaped plate to the right or to the left from its neutral position as shown in the drawings to engage either switch 56 or 57. These switches are mounted on the plate 46′ to the right and left of the L shaped plate.

The thumb arm 49 is pivotally mounted about the axis of pivot 54 to pivot upward and downward about a inclined near vertical plane to pivot the thumb receptacle upward and downward along a near vertical plane, downward and outward at angle when the right hand is in this position.

Movement of the thumb receptacle 23′ to the right or to the left on the forward pivot 50 on the thumb arm causes its left side wall 23″ to engage either the activation button 52′ or 53′ to trigger switches 52 or 53, respectively. These switches activate the “back space” or “cap lock”, respectively. Movement of the thumb receptacle 23′ to the right or to the left on the rear pivot in manner to pivot the thumb receptacle and thumb arm to the right or to the left on the rear pivot 48, without pivoting the thumb receptacle right or left on the thumb arm causes the L shape plate 47 of the thumb arm to pivot to the right or to the left to engage and trigger switches 56 or 57, respectively, which activates the “enter” or “space bar”, respectively. A cover 58 is fixed to the arm and provides the upper pivot 50 for the receptacle 23′. Movement of the thumb receptacle 23′ downward by the thumb will pivot the thumb receptacle and thumb arm downward and cause the thumb arm to engage and trigger switch 55, as previously indicated. This switch is mounted to the upward plate 46 which plate is fixed to the thumb main frame 45′.

Movement of the thumb receptacle downward by the thumb will cause the thumb receptacle and thumb to move downward and inward toward the fingers which corresponds to the natural movement of the thumb when it moves with the thumb arm 49, as the thumb, in its movement with the receptacle, will move naturally downward and inward for its downward movement. The thumb receptacle, in its right and left movement, when moved to the left, actually moves to the left and downward at an angle, and when moved to the right moves upward to the right at angle which corresponds to a natural movement of the thumb as the thumb easily and naturally move downward to the left and upward to the right, at an angle.

When the thumb and the fingers of the right hand are in position to operate the keyboard, the fingers are generally horizontal with the outer ends of the fingers directed downward and forward into the finger receptacles for normal operation; the right thumb of a person generally, when moved, moves in a path downward at angle to the left from a forward direction, outward at angle when the palm and inner ends of the fingers are generally horizontal with the outer ends of the fingers directed generally downward into the finger receptacles. The right thumb generally rests in the thumb receptacle 23′.

The one hand keyboard arrangement apparatus has one thumb receptacle and four finger receptacles to receive the thumb and four fingers of one hand of a person to operate the receptacles as a keyboard is as follows:

The four finger receptacles each have three movements, namely a forward and rearward movement and a down movement accomplished by the tips of the fingers moving in these three directions. The thumb receptacle has five movements as follows: a down movement, a forward right and forward left movement and a rearward right and rearward left movement. Switches are provided in the path of each of these movement for actuation.

Although, the keyboard is being described for a right handed keyboard, and accordingly, the letters on the keyboard run left to right in alphabetical order. A left handed keyboard could be provided with the order of movement also being left to right, to be described later, numerical order; while the fifth set provides eight keys for punctuation and other signals.

Typing the Alphabet, Numbers and Punctuation:

A. The Alphabet

When typing the alphabet, the thumb receptacle is only moved downward by the operator's thumb for its alphabet signals, while the finger receptacles are only moved forward and rearward by the operator's fingers for their alphabet signals. The fingers only move forward and rearward for the first third of the alphabet, without moving downward. The fingers move down only to change and maintain a new set of eight or nine alphabet signals, number signals, or punctuation signals being transmitted by the forward and rearward signal movement of the fingers.

In the right handed keyboard, the letters run left to right; the thumb, being on the left of the fingers provides, by its downward movement, the first letter of the first third of the alphabet, namely “a”, by engaging the switch 55 beneath the thumb receptacle, by pivoting the thumb receptacle and thumb arm downward.

The first third of the alphabet is provided without any downward movement of the finger receptacles. In other words, without engaging any of the shift switches of the four finger receiving apparatus.

The first third of the alphabet are the letters a-i, inclusive.

The first third of the alphabet, having begun by the downward movement of the thumb, provides the letter “a”. Thereafter, by the forward movement of the four fingers, left to right, of the right hand; this provides the letters “b, c, d, e”, respectively. The rearward movement of the four fingers, left to right, of the right hand provide the letters “f, g, h, i”, respectively, with none of the finger receptacles having moved downward to engage any of the shifting switches, when typing this first third of the alphabet.

The switch provided beneath each of the finger receptacles to be triggered by the finger downward movement provides the shifting movement from one set to the next.

The second third of the alphabet can be signaled, if the operator holds the far left finger receptacle 25 down with his finger to trigger the down shift switch 37, under the far left finger. Then, while, at the same time maintaining this far left finger receptacle down to maintain its switch triggered, moves any of the four fingers receptacles either forward or rearward or the thumb down to trigger their switches; any of the second succeeding set of nine letters of the alphabet can be signaled, as the program changes the signal of these nine switches.

The second third of the alphabet are the letters j-r, inclusive.

Thus, the second third of the alphabet will be provided by the operator maintaining the far left receptacle down while typing with the thumb and forward and rearward movement of the finger receptacles.

Thus, in this case, while maintaining the far left receptacle 25 down, the down movement of the thumb to engage switch 55 now provides the letter “j, and the forward movement of the four finger receptacles to engage their forward switches in succeeding order provides, left to right, the letters “k, l, m, n,”, respectively, and the rearward movement of the four finger receptacles in succeeding order, left to right, to engage their rearward switches provides the letters “o, p, q, r,”, respectively.

The third third of the alphabet are the letters s-z, inclusive.

The third third of the alphabet can be signaled, if the operator holds the left middle finger receptacle 25′ down to trigger the down switch 38 under the left middle finger receptacle 25′, while at the same time maintaining this switch triggered, moves any of the same four finger receptacles either forward or rearward; a third succeeding set of nine letters of the alphabet are provided, as the program further changes the signal of these eight switches. However, in this case, the down movement of the thumb is not used, as only eight signals are needed to complete the alphabet.

Thus, in this case, the forward movement of the four finger receptacles, left to right, provides the letters “s, t, u, v”, respectively; and the rearward movement of the four finger receptacles, left to right, provides the letters “w, x, y, z”.

Thus the entire alphabet is provided by these three sets of different signals, and is performed by the thumb and four finger receptacles with the signals on the keyboard arranged in succeeding alphabetical order for each set of the three sets. The operator, nevertheless, can select or choose a particular letter, by selecting the movement of one of the four receptacles or the thumb receptacle and selecting whether to move or hold one of the two finger receptacles downward.

B. Numbers:

If the operator wishes to type numbers, if the operator moves the right middle finger receptacle 25″ down to trigger the switch 39 beneath that finger receptacle, this provides a fourth set of different signals. This fourth set of nine signals are the numbers 1, 2, 3, 4, 5, 6, 7, 8, 9. In this case, however, the switch beneath the right middle finger receptacle will be a “push on push off” type switch, so that the operator may use, signal or type the numbers without having to hold that switch down. This enables the operator to signal numbers as long as he wants to without having at the same time hold the right middle finger receptacle 25″ down.

When he is done numbering, the operator will simply push his middle, tight finger receptacle 25′″ down again which will deactivate that switch 39. In this case, the down movement of the thumb provides the number “1”. The forward movement of the fourth finger receptacles, left to right, respectively, signals the numbers “2, 3, 4, 5”. The rearward movement of the fourth finger receptacles, left to right, respectively, signals the numbers “6, 7, 8, 9”

To provide the number “0” when typing numbers, there are several possibilities. One would be the have the operator hold the far right finger down, to activate this switch, and since, the switch beneath the right middle finger is a push on push off switch, it would remain activated. Then the program could provide any chosen one of the nine switches, in this case, if chosen, to provide the number “0”. In this case, the thumb down movement might provide the number “0”.

C, Punctuation:

If the operator wishes to type punctuation, he holds the far right finger receptacle 25′″ down. This triggers the only the switch 40 beneath that far right finger receptacle 25′″. This switch activation would cause a fifth set of signals for the same eight switches of the four fingers to be available in a program. The program, in this instance, would be for the punctuation.

For example, from ease of finger operation, there seems to be an advantage in having the far right finger pushed rearward, while holding the far right finger down, for the period “.” punctuation position. There also seems to be advantages, from ease of operation, in having the middle right finger pushed rearward while holding the far right finger down for the comma “,” punctuation.

Also, it seems to be advantage to having the middle right finger pushed forward or the far right finger pushed forward when holding the far right finger down for such punctuation as semi-colon or quotes, respectively.

Also, when typing numbers and punctuation, the punctuation down switch (fourth switch) should be a momentary switch and override the numbers switch the third switch(when the numbers switch is actuated) to momentarily override the numbers switch; so that punctuation, such as commas, may typed and then if the operator wishes to type more numbers he may do so; without having to reactivate the numbers switch.

Thus, the numbers switch should remain active, until the operator actually pushes the numbers switch a second time for the push off action to deactivate it.

Also, possibly, one might have the down switch for the far right finger switch to push on push off function, if the middle right down switch, push on push off, has been triggered on.

There are various options for numbers and punctuation.

Thumb:

The thumb receptacle 23′ serves two functions. It serves both as a control mechanism for the keyboard and serves a part of the actual typing of the alphabet and numbers.

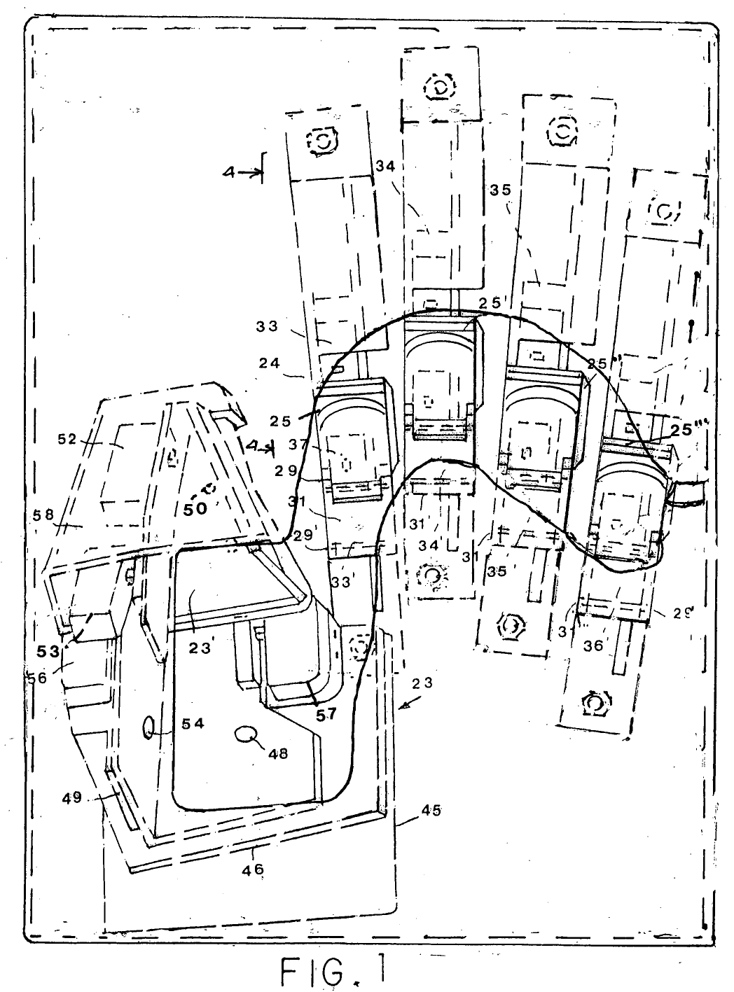

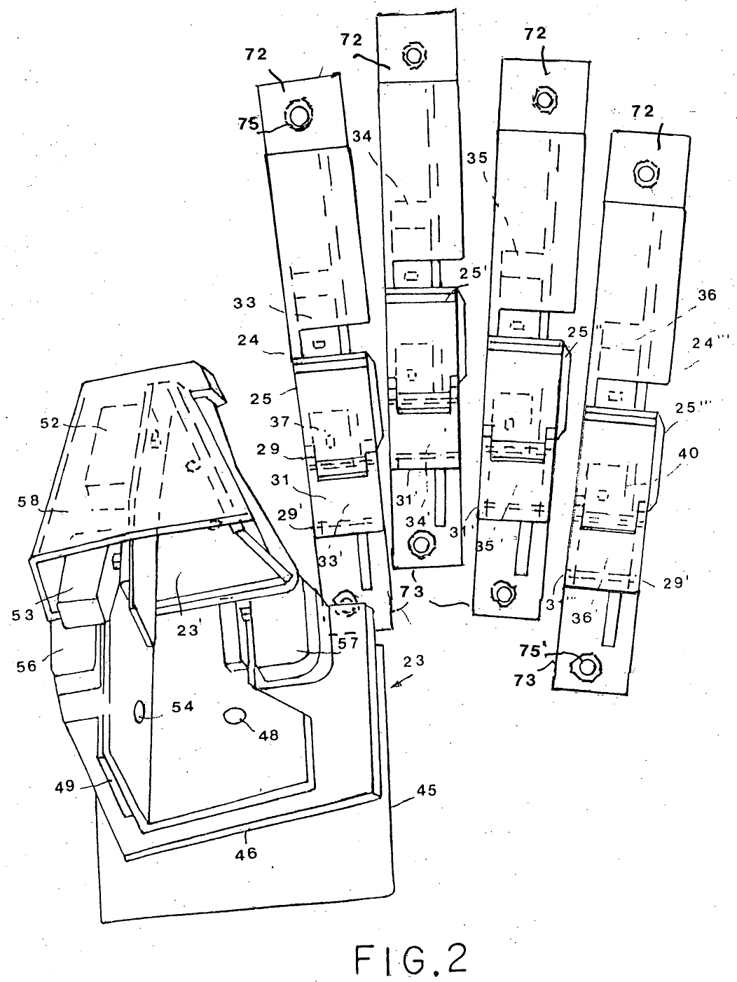

The thumb construction of the keyboard has a capacity for six movements. However, only five movements are currently being utilized. As indicated previously, the switch 55 is provided beneath the thumb 23′ for actuation by the down movement of the thumb, and the two switches 52 and 53 are provided ahead and behind, respectively, to the pivot 50 of the thumb receptacle to the arm for the engagement by counter clockwise and clockwise movement of the thumb on the arm; and the two switches 56 and 57 are provided on each side for counter clockwise and clockwise rearward left and right movement of the thumb on the L shaped plate on pivot 48 provide the four control signals: back space, capitol lock, enter, and space bar, respectively, when viewed from FIGS. 1 and 2.

The down movement of the thumb to engage switch 55 is for typing the letters “a”, “j”, or the number “1”. The thumb mechanism has a forward left and right and rearward left and right movements with switches which serve as control signals, when viewed from FIGS. 1 and 2.

The forward left movement of the thumb receptacle is a left counterclockwise movement of the thumb receptacle about the pin 50 of the arm, causes the thumb receptacle to engage a switch 52 to activate the “back space” signal of the keyboard.

The thumb receptacle has a flange 58 on the rear of the receptacle 23′ for the operator to engage to activate this “back space” signal. This flange 58 is directed at different angle 59 to the movement of the thumb main mechanism plate 47 about pivot 48, so that counterclockwise movement of the thumb receptacle 23′ by the thumb engaging the flange 58, the thumb only pivot the thumb receptacle 23′ counterclockwise about its forward pivot 50, when viewed from FIGS. 1 and 2, and will not pivot the main thumb and arm and L shaped plate about it's rear pivot 48 when it makes this movement.

If the thumb receptacle 23 is pivoted clockwise on the arm about its forward pivot 50, by the back of the thumb of the operator engaging the back flange 59 fixed to the thumb receptacle 23′; the “capitol lock” signal of the keyboard will activated.

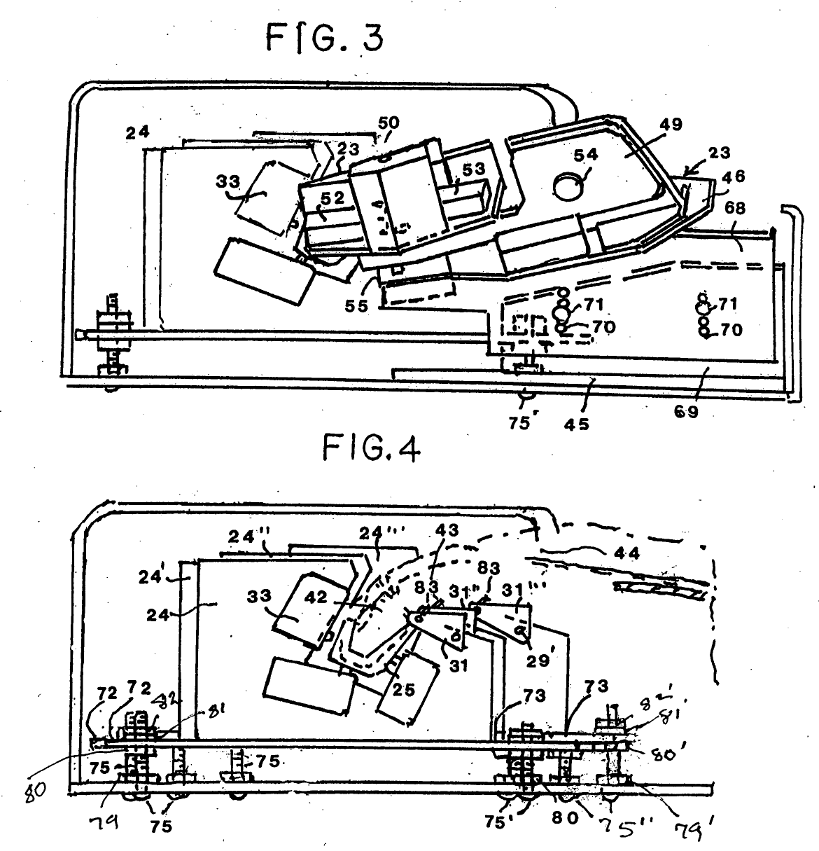

If the thumb arm and L shaped plate are pivoted counterclockwise when viewed from FIGS. 1 and 3 about the rear pivot 48, by the operator not moving the thumb receptacle relative to the arm by engaging the thumb receptacle at the middle of its length between the switches parallel to the moving the thumb receptacle 23′ in more of a shallow left counter clockwise movement; the mechanism will engage the switch 56 which activates the “enter” signal of the keyboard.

If the thumb arm and L shaped plate and thumb receptacle are pivoted clockwise about pivot 48, when viewed from FIGS. 1 and 2, by moving the thumb receptacle to the right, without pivoting the thumb receptacle on the arm; the L shaped plate 47 will engage the switch 57 to activate the “space bar”.

It is preferable that the thumb movement be to the right for the entering of the “space bar” signal, since the movement of the action of the space bar is in fact to the light on its typing action. This makes it easier for the operator to instantly recall what action in the device causes the space bar movement upon the screen where the typing action it taking place. Similarly, the movement of the thumb is back or to the left for the: “back space” signal as the action of the device upon the screen where the typing action is to the left or back so it makes it easier for the operator to instantly recall how to perform this action.

The Second Modification to the finger receptacle Operation Involves A Finger Arm for Each Receptacle

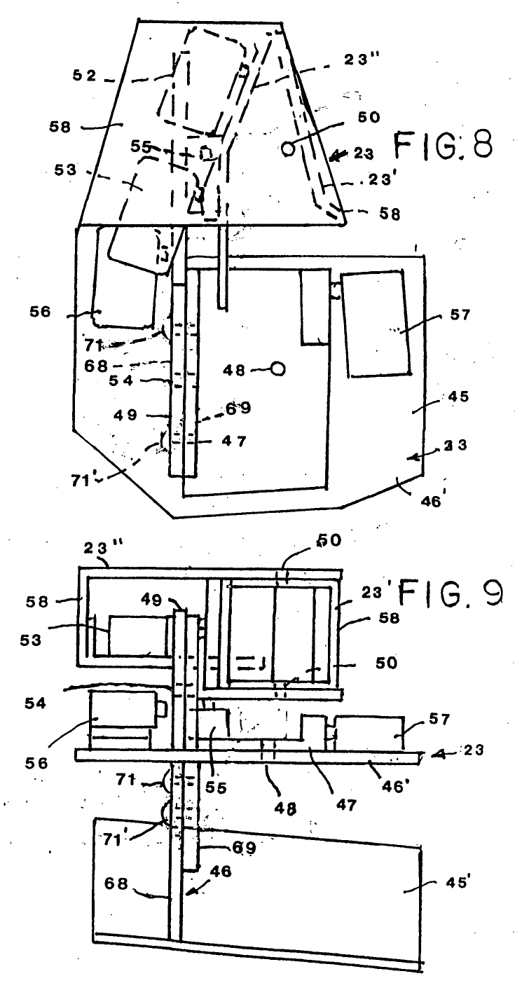

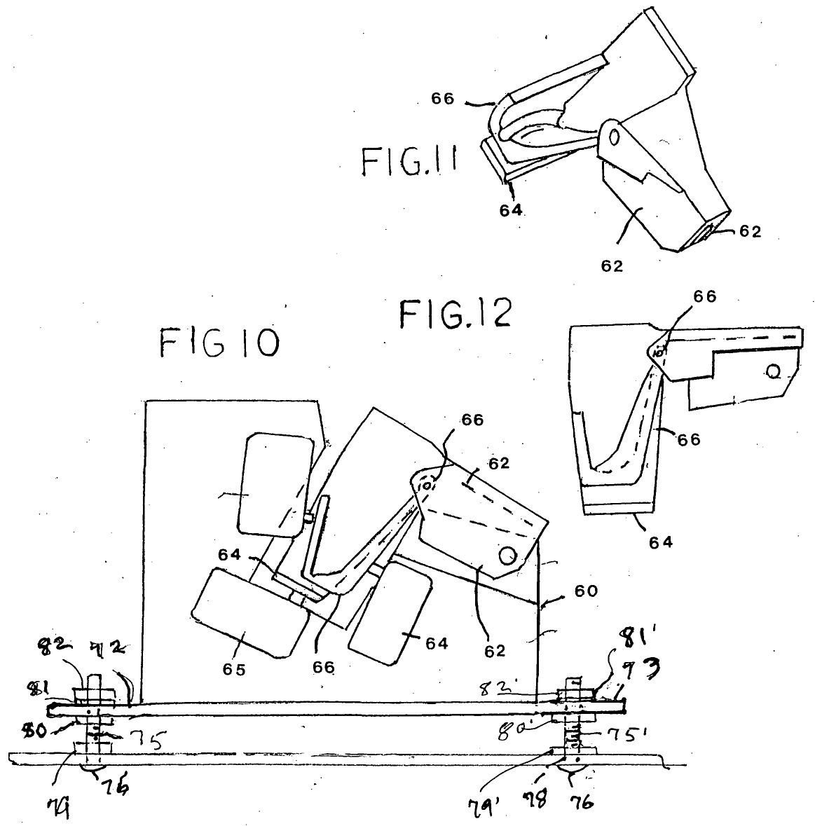

The finger arm modification is shown in FIGS. 10,11, and 12.

Each stand 60 has a horizontal base 60′ fixed across the bottom of the upright plate 60″ of the stand 60. The stand base 60′ is bolted to the main base 61. Each stand has three switches are, generally referred to by numerals 63,64, and 65 and are screwed to the upright base plate 60″. Each of the finger arms 62 has a rear support frame 62 with the rear support frame providing the flanges 62′ for the pivotal mounting of the arms to their respective stand at pivot 63. The finger receptacle 66 is pivotally mounted to the finger arm 62 at pivot 66′.

The operation of the finger arm modification is similar to the link concept, except the shift switches are activated by the downward movement of the finger arm through the receptacle with the bottom of the finger arm lateral flange 67 engaging the shift switch button 65′ of switch 65, rather than the bottom of the receptacle as in the link concept.

The forward switches are generally referred to by the numeral 63, the rearward switches are generally referred to by the numeral 64 and the shift switches are generally referred to by the numeral 65. Thus, the front and rear switches on each of the finger stands are signal switches to provide a signal for a particular letter or number, or punctuation, and etc. of the keyboard. The bottom switch of each finger stand changes the signals provided to the front and rear switches.

The thumb and finger receptacles are shown in the drawings in a neutral positions, with the finger receptacle and its arm being pivoted downward by the operator pushing the finger receptacle downward to cause the horizontal plate on the finger arm to engage its shift switch and by the finger receptacle being pivoted forward and rearward on the finger arm to engage the forward or rearward signal switches on each finger stand.

The four finger receptacles each may have an open side to enable the finger receptacles and their finger arms and fingers to be placed closer together.

Continuation in Part

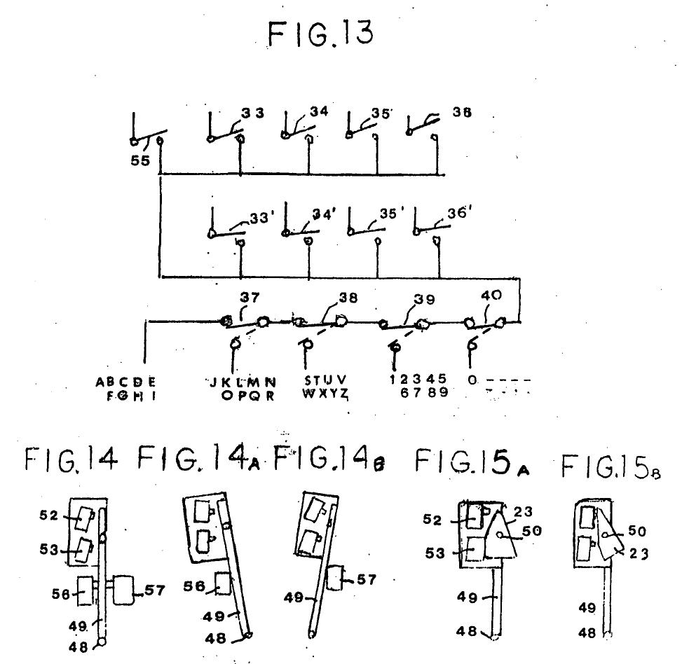

The subject matter being added by this continuation in part application is directed to primarily the finger and thumb structure to enable the fingers and thumb to be adjusted individually to different heights and angles to accommodate different thumbs and fingers of different size hands. A revision is also being made to the electrical circuit to correct an error in the circuit as illustrated. In order to illustrate the adjustment feature of the fingers and thumb the FIGS. 1-15 have been modified to show the adjustments.

In the thumb structure shown in FIGS. 3, 8 and 9, the main support plate 46 has been modified in to two separate plates 68 and 69 with the plate 68 having its upper edge fixed to the upper plate 46 and the plate 69 has its lower edge fixed the plate 45. Plate 68 has a plurality of bores 70 aligned vertically one above the other in two different locations and a pair of bolts 71 and 71′ securing the plate 69 at different heights. This enables the thumb receptacle 23′ to be adjusted to various heights relative to the base 45′ and relative to the four finger receptacles.

The four finger receptacles each have projecting front and rear flanges 72 and 73 with bores 74 to receive front and rear screws 75 and 75′. The screws 75 and 75′ have their heads 76 abutting the base of the main frame 77 and projecting upward through bores 78. Nuts 79 ad 79′ are threaded on to the screws 75 and 75′ to secure the screws in rigid relation to the base. The nuts 80 and 80′ are threaded on to the screws 75 and 75′ respectively below the projecting flanges 72 and 73 and the front and rear screws project upward through the bores 74. Locknuts 81 and 81′ are inserted onto screws 75 and 75′ and then nuts 82 and 82′ are threaded onto the screws 75 and 75′ downward to lock the flanges 72 and 73 in a fixed location. The nuts 80 and 80′ may be threaded downward and the nuts 82 and 82′ may also be threaded downward to move the flanges 72 and 73 of the finger frames downward to different positions.

The screws 75 and 75′ for each of the receptacle stands 30 by threading the various nuts upwardly and downwardly enable each of the stands 30 of each of the receptacles 24-24′″ to be adjusted individually to different heights and angles relative to the base 45′. This enables the finger receptacles to be adjusted to more comfortably receive and be operated by different size fingers and thumbs.

The four finger receptacles 24-24′″ have also been modified to add an upward projecting flange 83 fixed to the top of each receptacle above the pivot point to provide contact with the finger as a finger moves the receptacle by providing additional leverage by the finger to the receptacle to facilitate moving the receptacle to its various positions.

It will be obvious that various changes and departures may be made to the invention without departing from the spirit and scope thereof, and accordingly, it is not intended that the invention be limited to that specifically described in the specification or as illustrated in the drawings, but only as set forth in the appended claims wherein:

1. A finger mechanism comprising a frame, a elongated finger receptacle having a recessed socket bottom end for receiving the finger tip of the finger;
a link member having a forward and rearward pivot, said finger receptacle having an upper end pivot mounted to the forward pivot of the link member, with said forward pivot mounting of said link member at a location at least somewhat adjacent the first joint of the finger tip to the first section of the finger of any average length finger tips;
said link member at its rearward end pivotally mounted to the frame, at a location customarily adjacent the second joint of the finger so that the link member approximates an average length of many operator's fingers from the first to the second joint;
so that when the operator moves the receptacle with his finger tip and first and second joints of the finger, the receptacle and link member will more closely follow and imitate their movement for easier movement of the receptacle and link member by the operator's finger tip;
said frame having a front, rear, and bottom switch, said finger receptacle having a front, rear and bottom face for engagement and actuation of the front, rear, and bottom switches, with said front switch in front of the receptacle, the bottom switch beneath the receptacle, and the rear switch to the rear of the receptacle;
whereby, the operator may with his finger tip in the receptacle push his finger tip forward to move the receptacle forward to engage and actuate the front switch, and the forward movement of the receptacle lowers the receptacle link and straightens the joint connection between the receptacle and the forward pivot of the receptacle link, and similarly, the forward movement of the operator's finger lowers the first finger link of the operator's finger and straightens the joint connection between the finger tip and first finger link;
and whereby, when the operator pushes his finger tip rearward to cause the receptacle rear face to engage and actuate the rear switch, the rearward movement of the receptacle raises the linkage member of the receptacle; similarly, the rearward movement of the operator's finger raises the finger linkage of the operator's finger.

2. A keyboard for one hand comprising four finger receptacles and one thumb receptacle; a front and rear signal switch adjacent each of said four finger receptacles with said finger receptacles being movably mounted on upright stands to engage the two signal switches in a back and forth movement of the receptacles by an operator's four fingers, and a shift switch adjacent each finger receptacle with said finger receptacles movably mounted to selectively engage the shift switch for each finger receptacle with the downward movement of the finger receptacle;
said thumb receptacle being beside said finger receptacles being mounted on a thumb stand, a signal switch adjacent said thumb receptacle engagable by said thumb receptacle when the thumb receptacle is moved by the operator's thumb;
electrical circuitry means for said thumb signal switch and finger receptacle's signal switches providing a signal to said signal switches for a third of the alphabet, two of said shift switches for the finger receptacles selectively shifting the signal of the finger signal switches and thumb signal switch to the second and third of the entire alphabet, respectively, by the downward movement of the finger receptacle by the respective operator's finger causing the activation of the respective shift switch.

3. A keyboard according to claim 2 wherein the alphabet is arranged in alphabetical order beginning with the thumb signal switch and the succeeding finger receptacles signal switch in left to right forward and left to right backward order of the finger receptacle signal switches for each third of the alphabet.

4. A keyboard for one hand according to claim 3, wherein circuitry means to activate numbering signals for said thumb and four finger receptacle signal switches are activated upon downward engagement of a third one of said finger receptacles with a third one of said finger receptacles shift switches;
with said third switch being a push on push off switch whereby the switch once pushed will remain on by selecting numbers by movement of the selected finger receptacle wither back or forth or the thumb receptacle downward with the numbers arranged in numerical order beginning with the thumb signal switch and the succeeding finger receptacles signal switch in left to right forward and left to right backward order of the finger receptacle signal switches.

5. A keyboard for one hand according to claim 3, wherein said circuitry means includes means to activate punctuation signals for said finger receptacle switches upon the downward engagement of a fourth one of said shift switches by a fourth one of said finger receptacles.

6. A one hand right hand operated keyboard having four movable finger receptacles and one thumb receptacle for receiving and being moved by the four fingers and thumb, respectively, of one hand by an operator;
said four finger receptacles being laterally adjacent one another and extending downward with said thumb receptacle being to the laterally left of the finger receptacles, signal switch means adjacent to the front and to the rear of each of said finger receptacles to provide a set of eight signals for said finger receptacles and actuatable by movement of the finger receptacles by the operator's fingers;
a signal switch adjacent the thumb receptacle and actuatable by movement of the thumb receptacle by the operator moving his thumb;
shifting switch means adjacent each finger receptacle and actuatable in response to the downward movement of the respective finger receptacle by the operator's finger to change the set of signals provided to the eight signal switch means of the finger receptacles and the thumb signal switch.

7. A keyboard according to claim 6 with said finger receptacles each having levering means movably by the downward movement of the finger receptacle.

8. A thumb receptacle for a keyboard according to claim 1 wherein said thumb receptacle includes a thumb receptacle arm support, said thumb receptacle is pivotally mounted on said arm support to pivot about at least a somewhat near horizontal plane;
switch means on said arm support on each side of said thumb receptacle whereby when an operator places his thumb in the receptacle, the operator many pivot the receptacle with his thumb to one side to activate the other of the switch means;
switch means on each side of said thumb arm support whereby said operator may pivot said thumb receptacle and side thumb arm support with his thumb to one side or the other to activate one of said switch means on each side of said arm support;
one of said switch means activating a ‘back space’ function of a keyboard upon its activation, another of said switch means activating a ‘space bar’ function of a keyboard, upon its activation.

9. A thumb receptacle according to claim 8 wherein a third of said switch means activates function of a keyboard and a fourth of said switch means activating a ‘capitol lock’ function of a keyboard.

10. A thumb receptacle according to claim 9 wherein switch means allowed are provided beneath said thumb receptacle and wherein the thumb receptacle is pivotally mounted on said arm support to pivot downward to engage said switch means whereby an operator may pivot said thumb receptacle downward with his thumb to engage and activate and switch means and switch means beneath said thumb receptacle providing and letter ‘a’ ‘j’ and number ‘1’.

11. A one hand right hand operated keyboard according to claim 6 wherein said thumb and finger receptacles are individually adjustable upward and downward to enable the thumb and finger receptacles to accommodate different size hands.
